(19) United States
(12) Patent Application Publication
(10) Pub. No.: US 2024/0067255 A1
(43) Pub. Date: Feb. 29, 2024

(54) STEER-BY-WIRE ROAD WHEEL ACTUATOR MULTI-GROOVE BALL SCREW ANTI-ROTATION MECHANISM

(71) Applicant: Steering Solutions IP Holding Corporation, Saginaw, MI (US)

(72) Inventors: Christopher R. Case Myers, Freeland, MI (US); Caleb S. Palmer, Freeland, MI (US); Ryan D. Harris, Birch Run, MI (US); Eric D. Pattok, Frankenmuth, MI (US); Travis L. Palmer, Frankenmuth, MI (US); Bruce M. Collier, Saginaw, MI (US)

(21) Appl. No.: 18/457,594

(22) Filed: Aug. 29, 2023

Related U.S. Application Data
(60) Provisional application No. 63/402,620, filed on Aug. 31, 2022.
(60) Provisional application No. 63/417,223, filed on Oct. 18, 2022.
(60) Provisional application No. 63/429,517, filed on Dec. 1, 2022.

(51) Int. Cl. B62D 5/00; F16H 25/22; F16H 25/24

(52) U.S. Cl. CPC B62D 5/001; F16H 25/2204; F16H 25/2454; B62D 5/0424

(57) ABSTRACT

A steer-by-wire system for a vehicle includes a rack moveable in an axial direction and defining a groove extending in the axial direction of the rack. The steer-by-wire system also includes a housing surrounding at least a portion of the rack. The steer-by-wire system further includes an anti-rotation device disposed proximate an outer surface of the rack at the mounting location of the rack and within the housing. The anti-rotation device includes a plurality of balls disposed in the groove defined by the rack. The anti-rotation device also includes a running plate having a radially inner surface disposed radially outward of the rack, wherein the plurality of balls are disposed between the plate and the rack.

### CROSS-REFERENCE TO RELATED APPLICATIONS

This application claims the benefits of priority to U.S. Provisional Application Ser. No. 63/402,620, filed Aug. 31, 2022, U.S. Provisional Application Ser. No. 63/417,223, filed Oct. 18, 2022, and U.S. Provisional Application Ser. No. 63/429,517, filed Dec. 1, 2022.

### FIELD OF THE INVENTION

The disclosure of this application relates to electric power steering (EPS) systems and, more particularly, to a road wheel actuator anti-rotation mechanism for such EPS systems.

### BACKGROUND

Various electric power steering systems have been developed for assisting an operator with vehicle steering. One type of EPS system is referred to as a rack electric power steering (REPS) system. Some examples of steer-by-wire (SbW) road wheel actuators (RWAs) are simply ball screw based rack electric power steering systems without input shafts. In this configuration, a pinion gear shaft still engages rack teeth cut into the ball screw rack bar. This gear mesh provides two primary functions. First, a convenient rotating member for ball screw position sensing is provided. Second, an anti-rotation feature to prevent spinning of the ball screw occurs. If a steer-by-wire road wheel actuator is designed for a large vehicle, it may require the use of two ball nuts on the same ball screw to achieve the required output force. The addition of a rack and pinion mesh to this type of system would lead to an over-constraint condition since the center of the ball circuits in each ball nut defines the axis of the ball screw. The over-constraint is undesirable since it will lead to friction variation if parts are out of alignment.

### SUMMARY

According to one aspect of the disclosure, a steer-by-wire system for a vehicle includes a rack moveable in an axial direction and defining a groove extending in the axial direction of the rack. The steer-by-wire system also includes a housing surrounding at least a portion of the rack. The steer-by-wire system further includes an anti-rotation device disposed proximate an outer surface of the rack at the mounting location of the rack and within the housing. The anti-rotation device includes a plurality of balls disposed in the groove defined by the rack. The anti-rotation device also includes a running plate having a radially inner surface disposed radially outward of the rack, wherein the plurality of balls are disposed between the plate and the rack.

According to another aspect of the disclosure, a steer-by-wire system for a vehicle includes a housing. The steer-by-wire system also includes a rack moveable in an axial direction along a rack axis, at least a portion of the rack disposed within the housing, wherein the rack defines a first groove and a second groove extending generally parallel to the rack axis. The steer-by-wire system further includes an anti-rotation device disposed about an outer surface of the rack. The anti-rotation device includes a first plurality of balls. The anti-rotation device also includes a first running plate disposed between the rack and the housing, the first running plate extending in a longitudinal direction in generally parallel relation with the rack axis, wherein the first plurality of balls are arranged to roll between the first groove and the first running plate. The anti-rotation device further includes a second plurality of balls. The anti-rotation device yet further includes a second running plate disposed between the rack and the housing, the second running plate extending in a longitudinal direction in generally parallel relation with the rack axis, wherein the second plurality of balls are arranged to roll between the second groove and the second running plate. The anti-rotation device also includes a carrier having a first plurality of fingers and a second plurality of fingers, the first plurality of fingers retaining the first plurality of balls for rolling movement within the first groove, the second plurality of fingers retaining the second plurality of balls for rolling movement within the second groove.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a steering assembly with a rack electric power steering system;

FIG. 2 schematically illustrates a dual motor rack electric power steering system;

FIG. 3 is a perspective view of an anti-rotation mechanism for the rack electric power steering system disposed within a housing;

FIG. 4 is a cross-sectional view of the anti-rotation mechanism of FIG. 3;

FIG. 5A is a perspective view of the anti-rotation mechanism according to one aspect of the disclosure;

FIG. 5B is a perspective view of the anti-rotation mechanism according to another aspect of the disclosure;

FIG. 6 is a perspective view of the anti-rotation mechanism according to another aspect of the disclosure;

FIG. 7 is a perspective view of the anti-rotation mechanism according to another aspect of the disclosure;

FIG. 8 is a perspective view of the anti-rotation mechanism according to another aspect of the disclosure;

FIG. 9 is another perspective view of the anti-rotation mechanism of FIG. 8;

FIG. 10 is an elevation view of the anti-rotation mechanism of FIG. 8; and

FIG. 11 is a section view of the anti-rotation mechanism of FIG. 8.

### DETAILED DESCRIPTION

Referring now to the Figures, the embodiments described herein are used in conjunction with a steering assembly of a vehicle, such as a car, truck, sport utility vehicle, crossover, mini-van, marine craft, aircraft, all-terrain vehicle, recreational vehicle, or other suitable vehicles. As discussed herein, an electric power steering (EPS) system, including a steer-by-wire system, for example, includes an anti-rotation device where a pinion is not used in the steering system. The anti-rotation device resists rotation of a ball screw, rack or the like. Such rotation is induced by the loading of the threading of a ball nut.

As used herein, the terms screw, ball screw, and rack define a longitudinal member which is translated upon rotation of another member, such as a ball nut, for example. It is to be understood that the components may be used in various embodiments of the disclosure and are not limiting of other components which may be translated to carry out steering maneuvers.

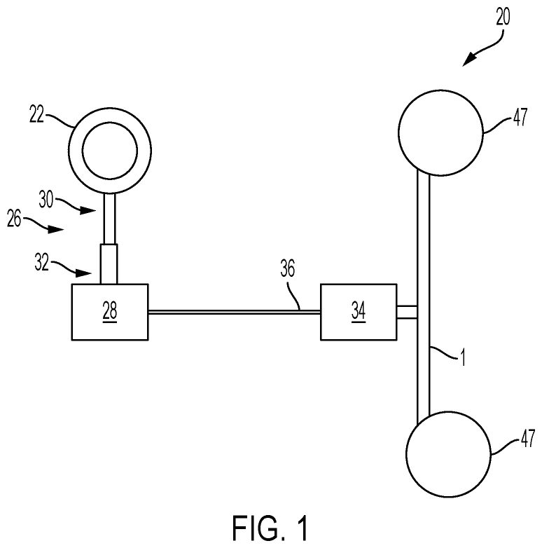

Referring initially to FIG. 1, a power steering system 20 is generally illustrated schematically. The power steering system 20 may be configured as a driver interface steering system, an autonomous driving system, or a system that allows for both driver interface and autonomous steering. The steering system 20 may include an input device 22, such as a steering wheel, wherein a driver may mechanically provide a steering input by turning the steering wheel. A steering column 26 extends along an axis from the input device 22 to an output assembly 28. The steering column 26 may include two or more axially and/or rake adjustable parts, such as a first portion 30 and a second portion 32 which are axially adjustable with respect to one another. However, only a single portion may be present in some embodiments. The embodiments disclosed herein are utilized in steering systems where the output assembly 28 is in operative communication with an actuator 34 that is coupled to a rack, such as a ball screw rack 1 having a helical screw/linear rack configuration. The output assembly 28 is in operative communication, such as wired communication 36 (e.g., steer-by-wire configuration) with the actuator 34. Translation of the rack 1 adjusts the road wheels 47 for steering maneuvers.

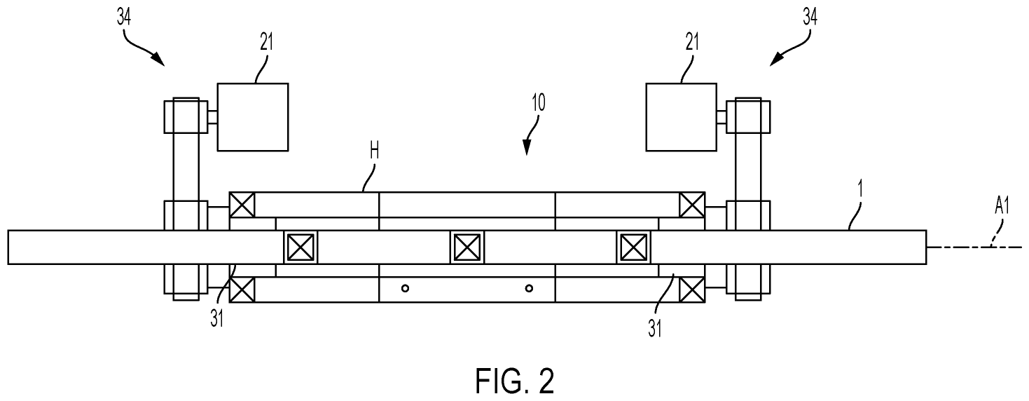

As illustrated in FIG. 2, the rack 1 is translated with at least one actuator, and possibly two or more actuators 34, by way of example and without limitation. Each actuator 34 includes a motor 21 and a ball nut 31 configured to drive the rack 1 for translation along a rack axis A1. The rack 1 is surrounded radially by a housing, referenced with H.

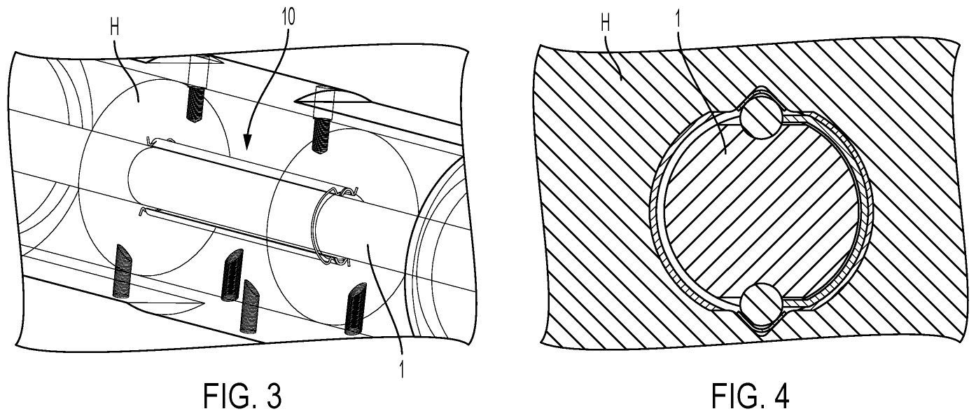

Referring now to FIGS. 3 and 4, the rack 1 and an embodiment of an anti-rotation mechanism 10 for the rack 1 are shown disposed within the housing H. The anti-rotation mechanism 10 resists rotation of the rack 1 during operation, as disclosed herein.

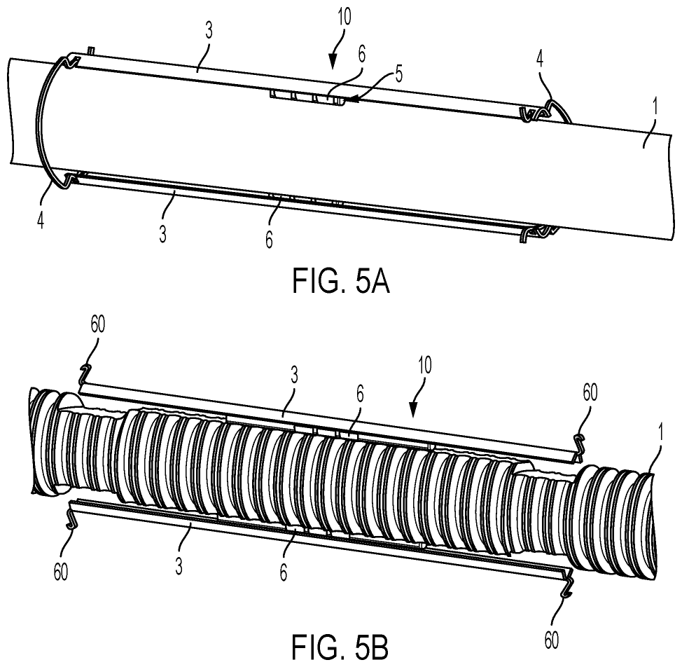

FIGS. 5A and 5B illustrate views of an anti-rotation mechanism 10 in accordance with embodiments disclosed herein. The anti-rotation mechanism 10 includes a pair of running plates 3 positioned in a bore of the housing H. The running plates 3 may be formed of any suitable material, such as metal. For example, the running plates 3 are formed of steel in some embodiments. Although a pair of running plates 3 are shown, it is to be appreciated that more or less running plates 3 may be provided in some embodiments. Each running plate 3 has a plurality of balls 6 disposed between an inner surface of the running plate 3 and the rack 1. In particular, each set of balls 6 are positioned within a groove 5 defined along an outer surface of the rack 1. Each groove 5 extends in the longitudinal direction of the rack 1 to allow the rack 1 to translate relative to the anti-rotation mechanism 10 which remains relatively stationary within the housing H. The balls 6 react against the running plate 3 and the groove 5 of the rack 1.

The running plates 3 are retained in the assembly axially, radially and circumferentially by spring members 4 in the embodiment shown in FIG. 5A. In particular, the spring members 4 each include a pair of end legs which are fixed to the housing H. A connecting portion of the spring members 4 couples the running plates 3 to each other. In another embodiment, the retention of the running plates 3 is facilitated by snap fingers 60 which are located at end regions of each running plate 3, as shown in FIG. 5B. The snap fingers 60 are resilient members capable of deflecting to be inserted and retained within a retention feature of the housing H.

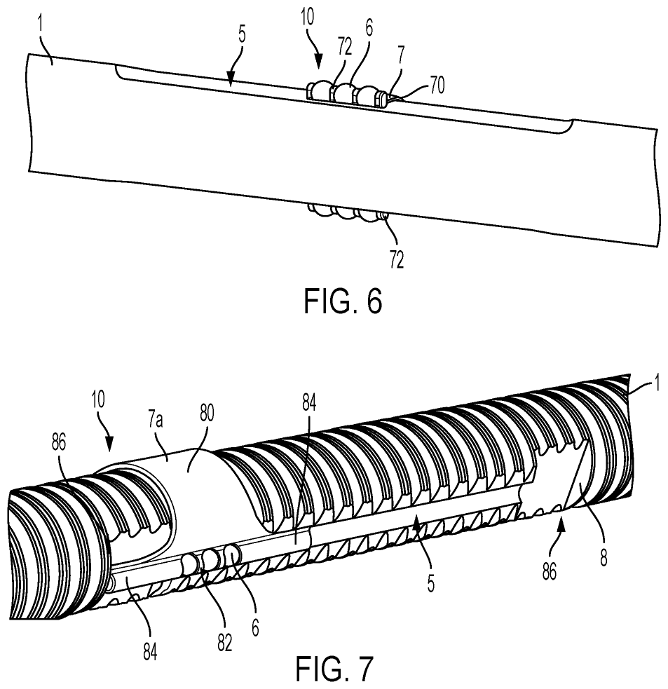

Referring now to FIG. 6, the anti-rotation mechanism 10 includes a carrier 7 which retains the balls 6 in the anti-rotation mechanism 10 to ensure smooth movement and ease of the rack 1 relative to the anti-rotation mechanism 10. The carrier 7 includes a main portion 70 extending around a portion of the outer diameter of the rack 1. In some embodiments, the carrier 7 is substantially C-shaped and extends approximately 180 degrees around the outer surface of the rack 1. A plurality of fingers 72 are formed on the ends of the main portion 70. The plurality of fingers 72 are provided to at least partially retain the balls 6 within the anti-rotation mechanism 10. In particular, adjacent fingers of the plurality of fingers 72 contain a respective ball 6 therebetween.

Referring to FIG. 7, another embodiment of the carrier is shown and referenced with 7a. The carrier 7a includes a main portion 80 extending around a portion of the outer diameter of the rack 1. In some embodiments, the carrier 7a is substantially C-shaped and extends approximately 180 degrees around the outer surface of the rack 1. A plurality of fingers 82 are formed on the ends of the main portion 80. The plurality of fingers 82 are provided to at least partially retain the balls 6 within the anti-rotation mechanism 10. In particular, adjacent fingers of the plurality of fingers 82 contain a respective ball 6 therebetween. The carrier 7a includes lateral edge regions 84 protruding in the axial direction of the rack 1 and away from the plurality of fingers 82. The lateral edge regions 84 provide added material on the ends of the carrier 7a to limit travel relative to the rack 1 based on the presence of a wall 86 created by at least one shoulder 8 defined at an end of the groove 5. For example, a machined flat surface on the rack 1 at an end of the groove 5 may be utilized as the travel limiter, but other structural features may be provided in other embodiments for interaction with the lateral edge regions 84.

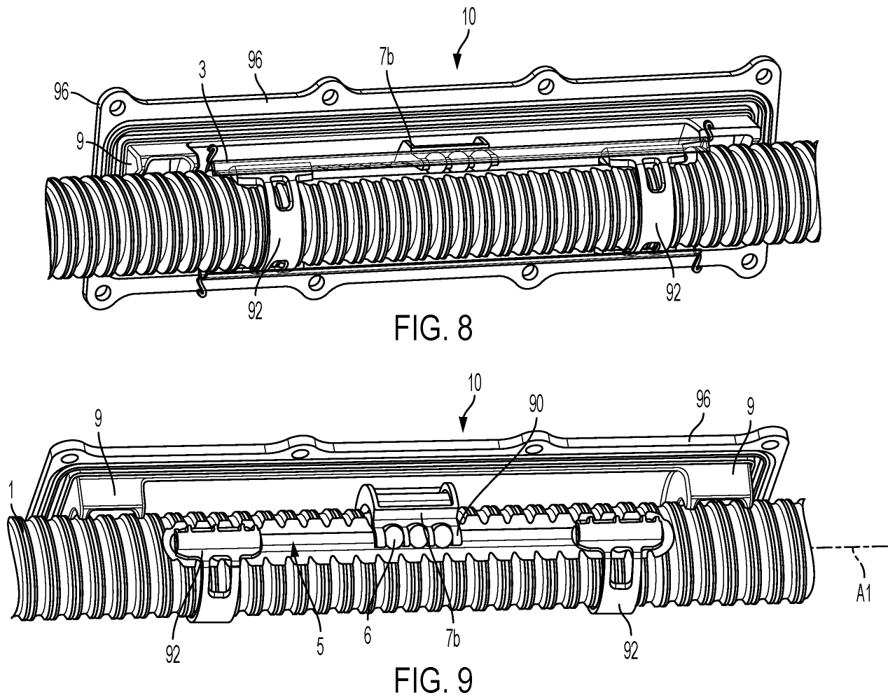

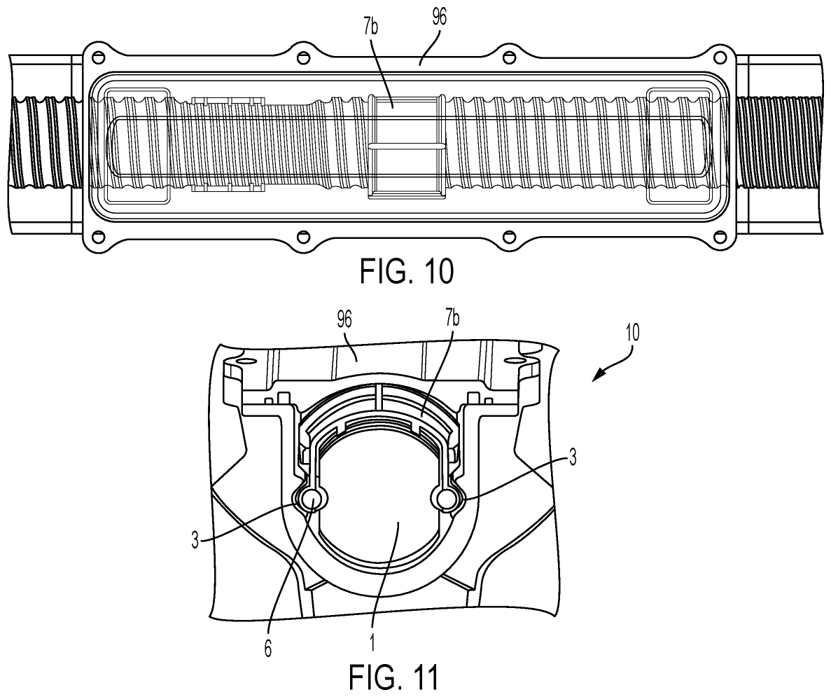

Referring to FIGS. 8-11, another embodiment of the anti-rotation mechanism 10 is illustrated. The carrier in the illustrated embodiment is referenced with 7b, but may be similar or even identical to the carrier 7 discussed above. The carrier 7b is supported against rotation about the rack axis A1, and can be fixed relative to the housing H in some embodiments. The carrier 7b is shown as being generally C-shaped, having ball retainers in the form of a plurality of fingers 90 on diametrically opposite sides of the rack 1 for rolling receipt of the balls 6 therein and for rolling receipt of the balls 6 in the grooves 5 of the rack or screw 1 extending substantially parallel to the rack axis A1 along diametrically opposite sides of the rack 1. A travel limiting mechanism 92 is used to limit travel of the carrier 7b relative to the rack 1. The travel limiting mechanism 92 may be present in the form of a pair, with one of each disposed at the end of the grooves 5.

A cover 96 is used for the aid of assembling the anti-rotation mechanism 10 into the center of the housing H. A sealing joint (e.g., RTV, PIP Seal, etc.) may be provided along with fasteners (e.g., screws) to attach the cover 96 to the housing H. The cover 96 may also incorporate travel limiters 9, as required. The use of colored carriers 7b can be used for ease of identification of different ball sizes in some embodiments.

Regardless of which of the embodiments are utilized, when a torsional load is applied from the rack or screw 1, the load is transferred through the groove 5 to the balls 6 into the running plate 3 into the housing H, thereby preventing rotation of the rack or screw 1. The balls 6 allow low friction translation in an axial direction along the groove 5. The size of the balls 6 or the stiffness of the running plate 3 can be adjusted to accommodate a required compliance for noise and friction characteristics. The number of grooves 5 and number of balls 6 may also be adjusted based on the system requirements for friction and torque as well as to minimize over-constraint of the system.

The embodiments disclosed herein provide several structural features and benefits, including, but not limited to: a ball and groove mechanization to resist torque in a road wheel actuator steering system; steel running surface plates retained by the use of a spring member; balls being retained by a carrier for assembly and function; one or more groove and ball combinations to resist rotation torque by the internal or external member; a carrier that also functions as a travel limiter; a ball screw with a feature that helps limit the travel of the carrier similar to the mechanization shown using a shoulder, and a side cover for assembly of the mechanization and the incorporation of travel limiters attached or incorporated into the cover.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

What is claimed is:

1. A steer-by-wire system for a vehicle comprising:
a rack moveable in an axial direction and defining a groove extending in the axial direction of the rack;
a housing surrounding at least a portion of the rack; and
an anti-rotation device disposed proximate an outer surface of the rack at the mounting location of the rack and within the housing, the anti-rotation device comprising:
a plurality of balls disposed in the groove defined by the rack; and
a running plate having a radially inner surface disposed radially outward of the rack, wherein the plurality of balls are disposed between the plate and the rack.

2. The steer-by-wire system of claim 1, wherein the running plate includes a first snap finger located at a first end region of the running plate and a second snap finger located at a second end region of the running plate, wherein the first snap finger and the second snap finger are coupled to the housing to retain the running plate to the housing.

3. The steer-by-wire system of claim 2, wherein the first snap finger and the second snap finger retain the running plate to the housing in an axial direction, a radial direction, and a circumferential direction.

4. The steer-by-wire system of claim 1, further comprising a carrier surrounding a portion of the rack, the carrier disposed between the rack and the running plate, wherein the carrier includes a plurality of fingers for retaining the plurality of balls disposed in the groove.

5. The steer-by-wire system of claim 4, wherein the carrier includes a first lateral edge region and a second lateral edge region, wherein the first lateral edge region extends away from the plurality of fingers in a first axial direction of the rack, wherein the second lateral edge region extends away from the plurality of fingers in a second axial direction of the rack.

6. The steer-by-wire system of claim 5, wherein the rack includes a first travel limit structure positioned to contact the first lateral edge region to limit relative travel between the carrier and the rack in a first direction.

7. The steer-by-wire system of claim 6, wherein the rack includes a second travel limit structure positioned to contact the second lateral edge region to limit relative travel between the carrier and the rack in a second direction.

8. The steer-by-wire system of claim 7, wherein at least one of the first travel limit structure and the second travel limit structure comprises a shoulder defined by a wall at an end of the groove.

9. A steer-by-wire system for a vehicle comprising:
a housing;
a rack moveable in an axial direction along a rack axis, at least a portion of the rack disposed within the housing, wherein the rack defines a first groove and a second groove extending generally parallel to the rack axis;
an anti-rotation device disposed about an outer surface of the rack, the anti-rotation device comprising:
a first plurality of balls;
a first running plate disposed between the rack and the housing, the first running plate extending in a longitudinal direction in generally parallel relation with the rack axis, wherein the first plurality of balls are arranged to roll between the first groove and the first running plate;
a second plurality of balls;
a second running plate disposed between the rack and the housing, the second running plate extending in a longitudinal direction in generally parallel relation with the rack axis, wherein the second plurality of balls are arranged to roll between the second groove and the second running plate; and
a carrier having a first plurality of fingers and a second plurality of fingers, the first plurality of fingers retaining the first plurality of balls for rolling movement within the first groove, the second plurality of fingers retaining the second plurality of balls for rolling movement within the second groove.

10. The steer-by-wire system of claim 9, further comprising at least one spring coupling the first running plate to the second running plate.

11. The steer-by-wire system of claim 10, wherein the at least one spring comprises a first spring and a second spring, the first spring coupled to a first end of the first running plate and to a first end of the second running plate, the second spring coupled to a second end of the first running plate and to a second end of the second running plate.

12. The steer-by-wire system of claim 11, wherein the first spring and the second spring are each fixed to the housing.

13. The steer-by-wire system of claim 9, wherein the carrier comprises a main body extending around an outer surface of the rack, wherein the carrier supports the first plurality of balls and the second plurality of balls to be positioned approximately 180 degrees from each other.

14. The steer-by-wire system of claim 9, further comprising a first travel limiting structure and a second travel limiting structure to limit relative travel between the carrier and the rack, the first travel limiting structure disposed proximate a first end of at least one of the first groove and the second groove, the second travel limiting structure disposed proximate a second end of at least one of the first groove and the second groove.

15. The steer-by-wire system of claim 14, further comprising a side cover operatively coupled to the housing.

16. The steer-by-wire system of claim 15, wherein the side cover includes a pair of travel limiters.

17. The steer-by-wire system of claim 9, wherein the first running plate and the second running plate each include a first snap finger located at a first end region of each running plate and a second snap finger located at a second end region of each running plate, wherein the first snap finger and the second snap finger are coupled to the housing to retain the running plates to the housing.

18. The steer-by-wire system of claim 17, wherein the first snap finger and the second snap finger retain the running plate to the housing in an axial direction, a radial direction, and a circumferential direction.

19. The steer-by-wire system of claim 9, wherein the carrier includes a first lateral edge region and a second lateral edge region, wherein the first lateral edge region extends away from the plurality of fingers in a first axial direction of the rack, wherein the second lateral edge region extends away from the plurality of fingers in a second axial direction of the rack.

20. The steer-by-wire system of claim 19, wherein the rack includes a first travel limit structure and a second travel limit structure, the first travel limit structure positioned to contact the first lateral edge region to limit relative travel between the carrier and the rack in a first direction, the second travel limit structure positioned to contact the second lateral edge region to limit relative travel between the carrier and the rack in a second direction.
